(19) United States
(12) Patent Application Publication
(10) Pub. No.: US 2007/0152475 A1
(43) Pub. Date: Jul. 5, 2007

(54) Motor vehicle with a side sill

(75) Inventors: Robert Harrison, Sankt Wolfgang (DE); Alfons Loibl, Weihmichl (DE); Paul Aschauer, Emmering (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/703,236

(22) Filed: Feb. 7, 2007

Related U.S. Application Data
(63) Continuation of application No. PCT/EP05/09700, filed on Sep. 9, 2005.

(30) Foreign Application Priority Data
Sep. 18, 2004 (DE) 10 2004 045 382.9

(51) Int. Cl. B62D 25/00

(52) U.S. Cl. 296/209

(57) ABSTRACT

A lateral door opening of a motor vehicle is delimited at the bottom by a side sill, which exhibits a supporting structure and an outer side panel. The outer side panel is hinged to the supporting structure by at least one quadruple joint so that the side panel can move from an effective position, in which it improves the aerodynamic properties of the motor vehicle, into a boarding position, in which the side sill is narrower than in the effective position from the perspective of the transverse direction of the vehicle, so that it is easier for a passenger to get in and out through the door opening as the passenger's legs have to be raised over the side sill when getting in and out. The narrower the side sill, the easier it is to get in and out. The functions of the supporting structure of the side sill with respect to rigidity and crash worthiness are not affected.

### CROSS-REFERENCE TO RELATED APPLICATIONS

This application is a continuation of PCT International Application No. PCT/EP2005/009700, filed on Sep. 9, 2006, which claims priority under 35 U.S.C. § 119 to German Application No. 10 2004 045 382.9, filed Sep. 18, 2004, the entire disclosures of which are expressly incorporated by reference herein.

### BACKGROUND AND SUMMARY OF THE INVENTION

The invention relates to a motor vehicle with a side sill.

German patent document DE 36 13 301 A1 discloses a passenger vehicle with a side panel in the region of a side sill. The side panel can be retracted and extended by way of actuating elements as a function of the driving speed. At higher driving speeds, the side panel in the extended position improves the aerodynamics of the motor vehicle, while in the retracted position when the motor vehicle is standing, the side panel does not have a negative impact on the look of the vehicle.

There is needed a motor vehicle with a side sill, which exhibits good aerodynamics when the vehicle is in motion and guarantees good boarding and alighting comfort.

This need is met by a motor vehicle with a lateral door opening, which is delimited at the bottom by a side sill. The side sill has a supporting structure and an outer side panel, which is hinged to the supporting structure by way of at least one quadruple joint, so that the outer side panel can move from an effective position, in which it improves the aerodynamic properties of the motor vehicle, into a boarding position, in which the side sill is narrower than in the effective position from the perspective of the transverse direction of the vehicle. As a result, it is easier for a passenger to get in and out through the lateral door opening.

According to the invention, a lateral door opening of a motor vehicle is delimited at the bottom by a side sill, which exhibits a supporting structure and an outer side panel. The outer side panel is hinged to the supporting structure by way of at least one quadruple joint so that the side panel can move from an effective position, in which it improves the aerodynamic properties of the motor vehicle, into a boarding position, in which the side sill is narrower than in the effective position from the perspective of the transverse direction of the vehicle, so that it is easier for a passenger to get in and out through the door opening as the passenger's legs have to be raised over the side sill when getting in and out. The narrower the side sill, the easier it is to get in and out. According to the inventive solution, the functions of the supporting structure of the side sill with respect to rigidity and crash worthiness are not affected.

Other advantageous designs and features are described and claimed herein.

Other objects, advantages and novel features of the present invention will become apparent from the following detailed description of the invention when considered in conjunction with the accompanying drawings.

### BRIEF DESCRIPTION OF THE DRAWINGS

The drawing depicts one embodiment of the invention, with which the invention is described in detail below. The individual figures are shown as schematic drawings, where

FIG. 1 is a sectional view of a side sill of a passenger vehicle with an outer side panel in an effective position;

FIG. 2 is a sectional view of the side sill of FIG. 1 with the outer side panel in a boarding position; and

FIG. 3 is a basic diagram of a mechanical coupling for moving the outer side panel as a function of a displacement of a side door of the passenger vehicle.

### DETAILED DESCRIPTION OF THE DRAWINGS

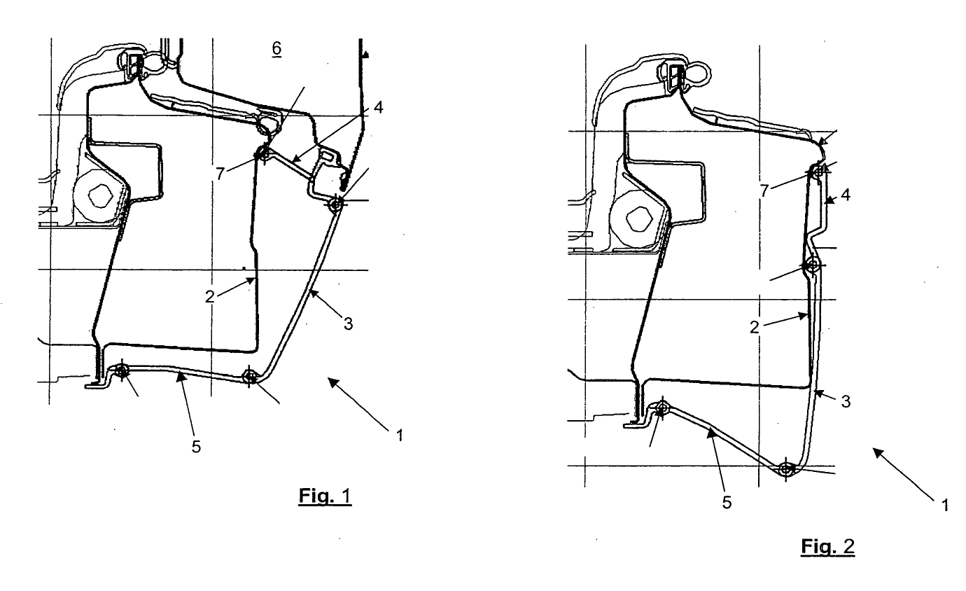

FIG. 1 and FIG. 2 show a side sill 1 of a passenger vehicle below a door opening. The side sill 1 is made of a supporting structure 2 in shell construction and an outer side panel 3. The outer side panel 3 is hinged to the supporting structure 2 by way of two control arms 4 and 5, which serve as a quadruple joint. In FIG. 1, the outer side panel 3 is located in an effective position, whereas in FIG. 2 it is located in a boarding position, which is folded downwardly and in the direction of the supporting structure 2. In the boarding position, the outer side panel 3 essentially rests against the supporting structure 2.

The door opening above the side sill 1 can be closed by way of a swivellable side door 6, which is located in a closed position in FIG. 1. When the side door 6 is opened, the outer side panel 3 swivels out of its effective position (FIG. 1) into the boarding position (FIG. 2). Inversely, when the side door 6 is closed, the outer side panel swivels out of the boarding position (FIG. 2) into the effective position (FIG. 1).

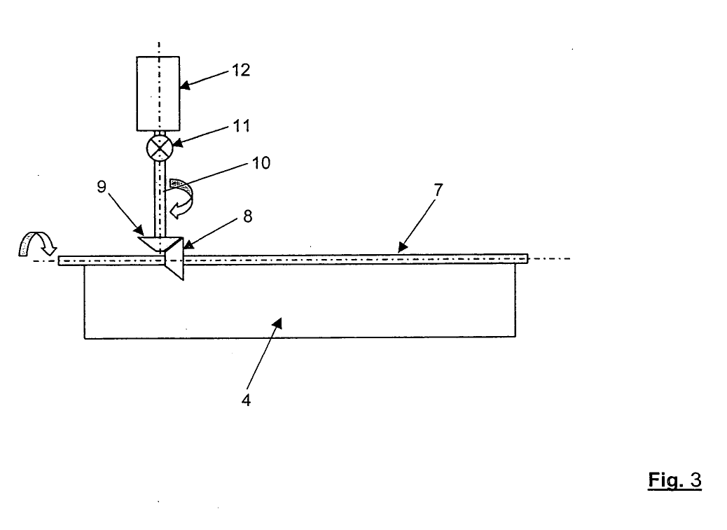

A preferred mechanism for carrying out the above movements is depicted schematically in FIG. 3. The top guide arm 4 is connected to the hinge axle 7, which is mounted swivellably on the supporting structure 2. Mounted on the hinge axle 7 is a bevel gear 8, which engages with another bevel gear 9. This other bevel gear 9 is connected on the bottom end of a rotatable shaft 10 to the rotatable shaft, the upper end of which is connected to a universal joint 11. The universal joint 11 is connected to a bolt 12 of a hinge, which is attached to the side door 6 and is hinged swivellably to a chassis of the passenger vehicle by way of the side door 6.

Therefore, when the side door 6 is opened, the outer side panel 3 swivels automatically—on account of a mechanical coupling—out of the effective position and into the boarding position, in which the side sill 1 is narrower by approximately 50 mm than in the effective position. The result is that it is easier for passengers to get in and out through the door opening. In addition, in the boarding position the outer side panel is located in a downwardly displaced position, so that the risk of soiling oneself or one's clothing on the dirty outer side panel 3 when boarding or alighting is reduced.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A lateral door opening of a motor vehicle, comprising:
a side sill delimiting a bottom of the lateral door opening, the side sill comprising a supporting structure and an outer side panel, which outer side panel is hinged to the supporting structure by way of at least one quadruple joint; and
wherein the side panel is movable via the at least one quadruple joint from an effective position, in which the side sill improves aerodynamic properties of the vehicle, into a boarding position, in which the side sill is narrower in a transverse direction of the vehicle than when the side sill is in the effective position, whereby the boarding position makes it easier for a passenger to get in and out through the lateral door opening.

2. The lateral door opening according to claim 1, wherein, in the boarding position, the outer side panel rests essentially against the supporting structure.

3. The lateral door opening according to claim 1, further comprising:
a side door for opening and closing the lateral door opening; and
wherein when the side door is opened, the outer side panel moves from the effective position into the boarding position, and when the side door is closed, the side door closes the lateral door opening.

4. The lateral door opening according to claim 2, further comprising:
a side door for opening and closing the lateral door opening; and
wherein when the side door is opened, the outer side panel moves from the effective position into the boarding position, and when the side door is closed, the side door closes the lateral door opening.

5. The lateral door opening according to claim 3, wherein the at least one quadruple joint includes a guide arm, the lateral door opening further comprising:
at least one hinge operatively configured to hinge the side door to a chassis of the motor vehicle; and
wherein a section of the at least one hinge on the side door is mechanically coupled to the guide arm for moving the outer side panel between the effective and boarding positions.

6. The lateral door opening according to claim 4, wherein the at least one quadruple joint includes a guide arm, the lateral door opening further comprising:
at least one hinge operatively configured to hinge the side door to a chassis of the motor vehicle; and
wherein a section of the at least one hinge on the side door is mechanically coupled to the guide arm for moving the outer side panel between the effective and boarding positions.

7. A motor vehicle, comprising:
a frame construction forming a lateral door opening;
a side door for opening and closing the lateral door opening;
wherein the lateral door opening comprises a side sill delimiting a bottom of the lateral door opening; and
wherein the side sill includes a supporting structure and an outer side panel, the outer side panel being hinged to the supporting structure via at least one quadruple joint such that the outer side panel is movable between an effective position, in which aerodynamic properties of the motor vehicle are improved, into a boarding position in which the side sill is narrower in a transverse direction of the vehicle than in the effective position.

8. The motor vehicle according to claim 7, wherein when in the boarding position, the outer side panel rests essentially against the supporting structure.

9. The motor vehicle according to claim 7, wherein when the side door is opened, the outer side panel is moved from the effective position into the boarding position.

10. The motor vehicle according to claim 8, wherein when the side door is opened, the outer side panel is moved from the effective position into the boarding position.

11. The motor vehicle according to claim 9, further comprising a door side hinge for hinging the side door to a chassis of the motor vehicle, the door-side hinge being mechanically coupled to a guide arm of the quadruple joint for mechanically moving the outer side panel into the boarding position when the side door is opened.
